(19) United States
(12) Patent Application Publication
(10) Pub. No.: US 2026/0034521 A1
(43) Pub. Date: Feb. 5, 2026

(54) Apparatus and Method for In-Bottle Wine Aeration

(71) Applicant: Paul Samuel Carastro, Tampa, FL (US)

(72) Inventor: Paul Samuel Carastro, Tampa, FL (US)

(21) Appl. No.: 19/289,032

(22) Filed: Aug. 2, 2025

Related U.S. Application Data
(60) Provisional application No. 63/678,605, filed on Aug. 2, 2024.

(51) Int. Cl. B01F 23/2361; B01F 33/501; B01F 101/17

(52) U.S. Cl. CPC B01F 23/2361; B01F 33/5011; B01F 2101/17

(57) ABSTRACT

An aerator for acrating wine in a bottle, comprising a reservoir mounted relative to the neck of the bottle, a pump for pumping wine from the bottle into the reservoir to thereby create a headspace within the bottle exposed to atmospheric air, and a drainpipe for directing wine overflowing from the reservoir back into the headspace of the bottle, thereby acrating the wine in the bottle.

### CROSS-REFERENCE TO RELATED APPLICATIONS

This application claims the benefit of provisional patent application No. 63/678,605, filed Aug. 2, 2024, the disclosure of which is hereby incorporated by reference herein.

### BACKGROUND OF THE INVENTION

### Field of the Invention

This invention relates to wine aerators for aerating wine to introduce oxygen into

the wine, which softens the tannins, releases the flavors and aromas, and improves the overall texture. More particularly, this invention relates to wine aerators that are temporarily fluidly connected to the neck of a wine bottle during aeration.

### Description of the Background Art

Presently there exist numerous types of wine aerators designed to mix atmospheric air into wine to increase exposure to oxygen. The primary goal of aeration is to expose wine to oxygen before consuming it to “open up” the wine, by bringing out its flavors and softening tannins. Representative examples of prior art patented or patent pending wine aerators believed to be the most relevant to the subject invention are set forth in U.S. D850,195, U.S. Pat. Nos. 11,980,853, 9,579,612, 9,168,495, 8,561,970, 6,508,163, 5,595,104, US 2010/0058933, US2020/0269198 and DE29604406, the disclosures of which are hereby incorporated by reference herein.

One method of aeration involves transferring wine from a bottle to a vessel, such as a decanter, and letting the wine sit in the decanter for a certain period of time. Depending on the type of wine and its age, it may need to sit for 30 minutes to 2 hours, which delays the enjoyment of the wine. Another method involves a person holding two reservoirs, such as pitchers, and pouring the wine back and forth from one reservoir to the other. This process requires the use of multiple reservoirs and physical exertion by a person.

Another category of wine aerators comprises a mechanical pump to push atmospheric air into the wine within a bottle, essentially injecting oxygen into the wine. Devices in this category such as disclosed in Patents '195, '970 and '198, generate a plethora of bubbles, which, depending on the wine, will create foam overflowing out of the bottle. The device disclosed by Patent '198 includes an expansion chamber positioned above a wine bottle to accommodate foam flowing out of the bottle.

Patent '163 teaches out-of-bottle wine aerators affixed to the neck of a bottle of wine (after cork removal) involving withdrawing wine from the wine bottle, flowing it over an external dome-shaped surface in the aerator to expose the wine to air, and then returning the aerated wine to the bottle. In lieu of the external dome-shaped surface, Patent '163 teaches an alternative embodiment of spraying the wine in an external bubble chamber for aeration and then returning the aerated wine to the bottle. Patent '853 teaches a further improvement to Patent '163 of including a plurality of incisions on its return pipe to create a venturi effect to further aerate the wine.

Prior art wine aerators known to aerate wine in conjunction with a wine bottle, suffer from several disadvantages. Firstly, injecting air into wine within a bottle, especially full body red wines, leads to a buildup of foam that can overflow out of a bottle. Air injection type devices can impart a bubbly appearance to wine. Excluding intentionally bubbly wines, such as sparkling wine and champagne, bubbly wine is generally considered to be unpleasant. Finally, unless air injection is done at the very bottom of a wine bottle, a portion of the wine in the bottle remains unaerated. However, injecting air at the bottom of a bottle will disturb the sediment, also called dregs, at the bottom of the bottle that will then need to be strained out before the wine is consumed.

Therefore, an object of this invention is to provide an improvement which overcomes the aforementioned inadequacies of the prior art devices and provides an improvement which is a significant contribution to the advancement of the wine aeration art.

Another object of this invention is to aerate wine in a bottle to eliminate the burden of having to transfer the wine from a bottle to another vessel. Wine is aerated in the wine bottle, and the wine remains in the bottle for serving.

Another object of this invention is to aerate wine in a bottle without generating bubbles, preventing foam from overflowing out of a wine bottle and without imparting a soapy appearance to the wine.

Another object to this invention is to reduce the amount of time to aerate wine thereby enabling a consumer to enjoy the aerated wine sooner.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, the invention comprises an in-bottle wine aerator having a base configured to be mounted into the neck of a wine bottle after removal of the wine cork. The base comprises one or more air vents allowing atmospheric air, while the base is mounted into the neck of the wine bottle, to be freely drawn into the headspace above the level of the wine in the bottle.

The aerator comprises a pump having a tube fluidly connected thereto and extending from the base below the surface of the wine in the wine bottle. While the pump is activated, wine is pumped from within the bottle via the tube into a reservoir in the aerator for temporarily storing a volume of wine pumped therein from the wine bottle, thereby significantly enlarging the headspace and volume of air above the level of the wine in the bottle.

The pump may operate for a predetermined time or on demand, to pump wine from the bottle into the reservoir. The reservoir includes an overflow drainpipe defining the height of the wine in the reservoir as it fills, such that continued operation of the pump results in excess wine overflowing into the drainpipe back into the neck of the wine bottle for aeration within the now-very-enlarged headspace of atmospheric air above the level of the wine in the bottle to aerate the wine therein. Importantly, the enlarged headspace facilitates an increased exposure of the wine to the oxygen in the atmospheric air in the headspace.

The reservoir comprises a plurality of bleed holes to continuously bleed (drain) the reservoir of wine into the drainpipe. In the preferred embodiment, the pump is operated over four cycles—60 seconds on followed by 15 seconds off to allow bleeding of the wine in the reservoir after each cycle, thereby refreshing the atmospheric air in the headspace H.

Importantly, pumping the wine from within the bottle into the reservoir of the aerator creates a larger headspace in the bottle above the level of the remaining wine in the bottle, thereby assuring that adequate aeration of the wine occurs in the bottle itself. Furthermore, unlike the prior art aerators that create undesired bubbling during aeration, the aeration of the subject invention occurs within the bottle without creating bubbles.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view, in partial ¼ section, of the wine aerator of the invention seated on a bottle;

FIG. 2 is a schematic drawing of the wine aerator of FIG. 1;

FIG. 3 is a cross-sectional view of the upper assembly of the wine aerator of FIG. 1;

FIG. 4 is a cross-sectional view of the lower assembly of the wine aerator of FIG. 1 having a downwardly extending boss that fits into the neck of the wine bottle to be mounted thereto;

FIG. 5A is a perspective view of an elastomeric gasket that mounts onto the downwardly extending boss for mounting into the neck of a bottle while providing airflow therethrough into the headspace of the bottle;

FIG. 5B is a cross-sectional view of FIG. 5A along lines 5A-5A;

FIG. 5C is a cross-sectional view of an alternative embodiment of the drainpipe press-fitted onto an upstanding crenellated annular support formed in the bottom of the reservoir to define bleed holes for draining the reservoir;

FIG. 6 is a flow chart of the wine aerator control program; and

FIG. 7 is an exploded view of the aerator showing mounting onto a bottle.

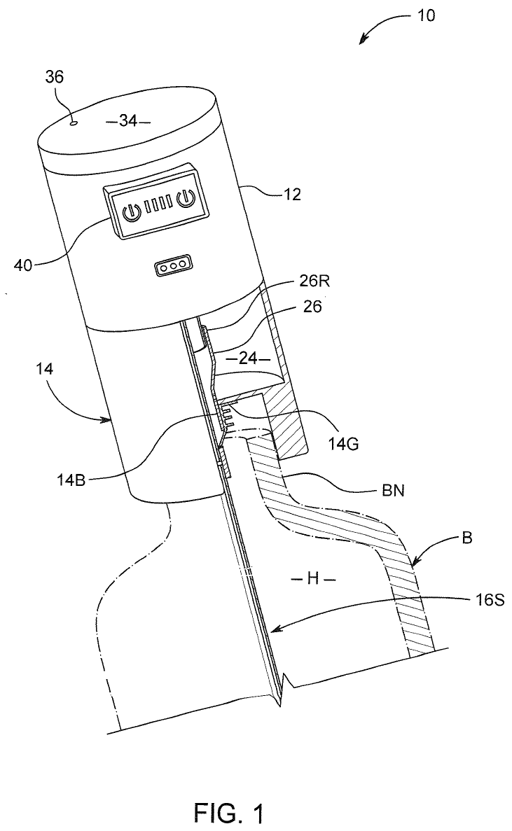

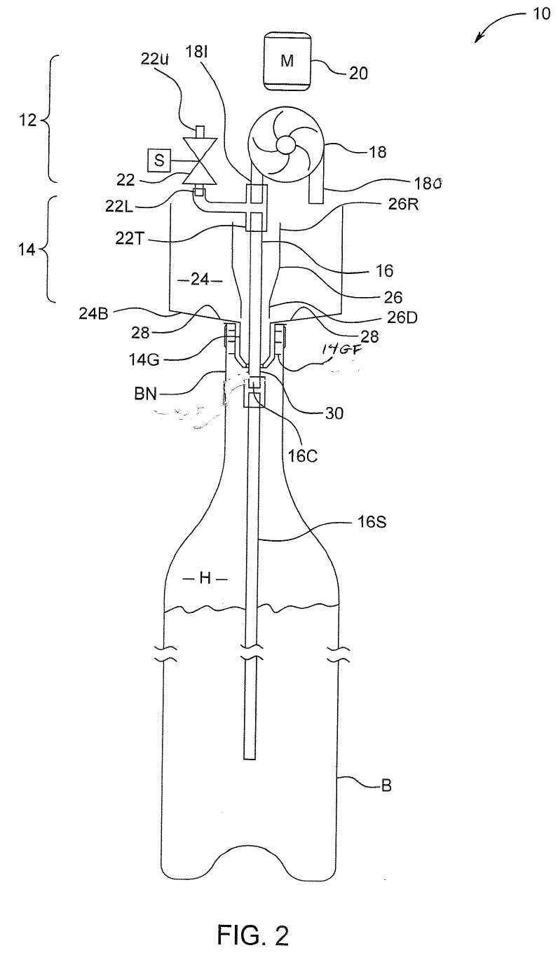

Similar reference characters refer to similar parts throughout the several views of the drawings.

### DETAILED DESCRIPTION OF THE PREFERRED EMBODIMENT

The in-bottle aerator 10 of the present invention comprises a generally cylindrical shape comprising an upper assembly 12, a lower assembly 14, and an intake tube 16. The lower assembly 14 comprises a downwardly extending boss 14B dimensioned to fit into the neck BN of a bottle B of wine by means of an elastomeric gasket 14G. The intake tube 16 fits through the boss 14 and then through a center hole 14GC formed in the gasket 14G. An elongated suction tube 16S is fluidly fitted to the input of the intake tube 16 by a fluid coupler 16C to extend into the bottle B.

A self-priming liquid pump 18 is operatively powered by an electric motor 20. The pump 18 comprises an inlet port 18I for drawing liquid and an outlet port 18O for discharging liquid. A normally-open, preferably solenoid-operated, air valve 22 having an upper port 22U and a lower port 22L with its upper port 22U fluidly connected to atmospheric air and its lower port 22L fluidly connected in-line with the intake tube 16 (and hence to the input 18I of the pump 18) via a tee fitting 22T.

A reservoir 24 is positioned elevationally below the output 18O of the pump 18 such that wine can be suctioned from within the bottle B via suction tube 16S and intake tube 16 into the reservoir 24. During operation of the pump 18, wine is continuously pumped from within the bottle B up through the suction tube 16S and intake tube 16 to continually discharge into the reservoir 24, exposing the wine to atmospheric air within the reservoir.

An open-ended overflow drainpipe 26 is positioned vertically within the reservoir 24 with its upper rim 26R functioning as a weir to determine the level of wine in the reservoir 24 and with its discharge end 26D, connected to boss 14B, fluidly connected to the headspace H above the level of the wine in the bottle B. Preferably, for fuller exposure to atmospheric air in the headspace H, overflow 26 comprises a drainpipe configuration to continuously drain overflowing wine from the reservoir 24 through boss 14B and through gasket 14G, down the outer surface of the suction tube 16S and/or along the interior surface of the bottle B.

With the pump 18 being turned off, the reservoir 24 would normally remain full of wine to the level determined by the upper rim 26R of the overflow drainpipe 26. The reservoir 24 is continuously drained by a plurality of bleed holes 28 positioned in the bottom of the reservoir 24; however, it is to be understood that the rate of flow of wine being pumped into reservoir 24 is appreciably greater than the rate the wine bleeds out of bleed holes 28.

Further, the bottom 24B of reservoir 24 is preferably sloped downwardly toward the overflow drainpipe 26 to enhance drainage of the reservoir 24 via the plurality of bleed holes 28. It is noted that the drainpipe 26 is easily fitted onto the drain hole 30 during set-up but still leaves sufficient spaces forming bleed holes 28 via the embrasures (crenels or crenelles) to bleed the wine from the reservoir 24.

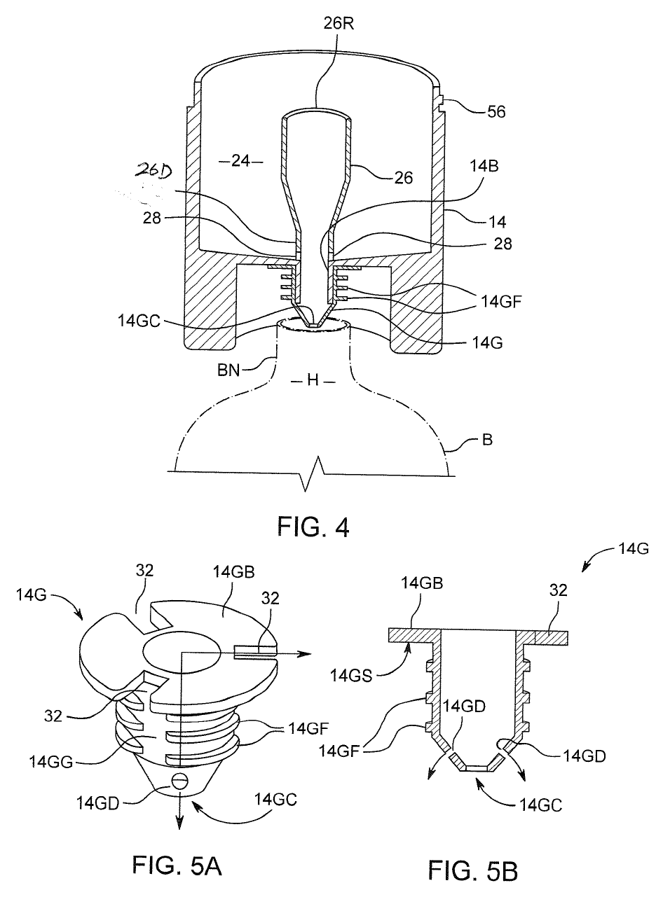

As shown in FIG. 4, preferably the drainpipe 26 and boss 14B (and gasket 14G) are concentric with one another such that the smaller-diameter intake tube 16 fits concentrically within the larger-diameter drainpipe 26. Hence, the bleed holes 28 are in fluid communication with the annular space between the outside of the smaller-diameter intake tube 16 and the inside of the boss 14B.

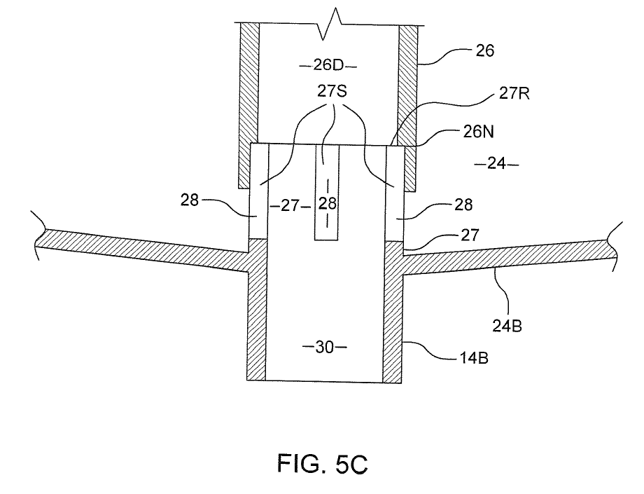

An alternative embodiment of the drainpipe 26 configuration is shown in FIG. 5C. Instead of the drainpipe 26 and reservoir 24 being produced integrally by 3-D printing, the drainpipe 26 may be injection molded as a separate component with its bottom end notched to be fitted onto an annular mount 27 extending upwardly from the bottom 24B of reservoir 24. The annular mount 27 comprises a plurality of longitudinal slots 27S formed therein in a crenellated configuration such that when the drainpipe 26 is mounted thereon during set-up and pushed downwardly to seat its notch 26N on the upper rim 27R thereof, the remaining lowermost exposed portions of the slots 27S function as the previously-described bleed holes 28.

During operation, wine being continuously bled from the reservoir 24 via the bleed holes 28 and drainpipe 26 drains out of the gasket 14G via its drain holes 14GD formed circumferentially therein and flow by gravity into the headspace H of the bottle B with wine draining along the inside surface of the bottle B and along suction tube 16S for full aeration.

As alluded to earlier, as shown in FIGS. 5A and 5B, the lower assembly 14 comprises a downwardly extending boss 14B formed in the bottom 24B for mounting into the neck BN of the bottle B by means of the gasket 14G. The gasket 14G comprises a T-hat configuration with a wide brim 14GB extending substantially radially to form a seat 14GS for sealing the upper rim of the bottleneck BN with the boss 14B. A plurality of radial slots functioning as air vents 32 are formed in the brim 14GB to allow atmospheric air to freely flow into the headspace H of the bottle B at all times, thereby assuring the headspace H above the level of the wine in the bottle B remains open to atmospheric air. Further, gasket 14G, being of an appreciable diameter smaller than the diameter of the bottleneck BN, preferably includes a plurality of pliable horizontal fins 14GF that may more securely affix the boss 14B in the bottleneck BN. The fins 14GF are interrupted at gap 14GG to not otherwise obstruct airflow through vents 32.

The upper assembly 12 preferably comprises a lid 34 enclosing the top of the housing of the upper assembly 12, the lid 34 including lid vent port 36 open to the atmosphere. A control panel 40 attaches to the exterior of housing with pushbuttons for powering the motor 20 and associated electronics on and off, and LED indicating lights for monitoring the aerator 10. In another embodiment, control panel 40 is a single push button. In still other embodiments, control panel 40 is a touch screen panel with a graphic display. A printed circuit board 42 contains electrical components and connectors for controlling the aerator 10. A rechargeable battery 44 powers the circuit board 42, pump 18, valve 22, and control panel 40.

The upper assembly 12 further includes a bottom panel 48 to enclose the underside of the upper assembly 12, the bottom panel 48 including a vent port 50. A vent tube 52 comprising a 3-way flexible tube, one end connecting to the lid vent port 36, a second end connecting to the input 22L of valve 22, and a third end connecting to the bottom panel vent port 50. It is noted that valve 22 is preferably open during initial set-up, to preclude a vapor trap occurring within the volume of the suction tube 16S and intake tube 16 that might otherwise overflow the wine from the bottle B during the initial insertion of the suction tube 16S into a full bottle of wine during set-up.

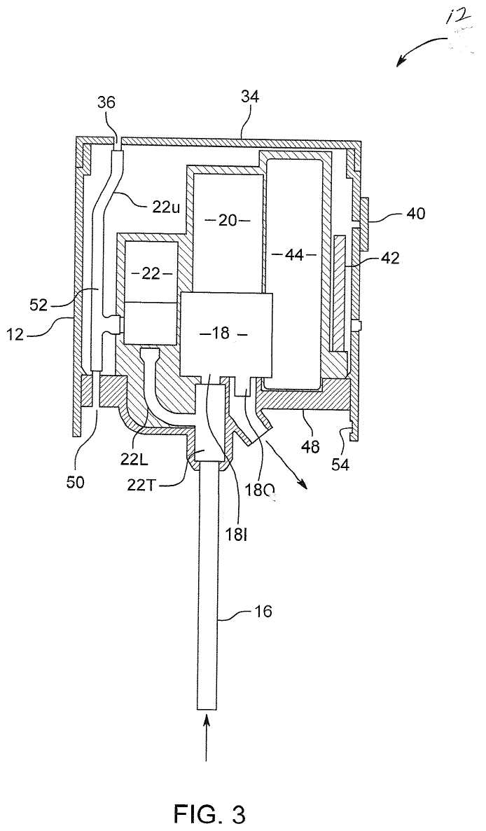

Referring to FIGS. 3 and 4, the upper assembly 12 is connected to the lower assembly 14 by means of a complementary twist-lock wherein one assembly 12 or 14 includes a locking rim 54 that fits into the other assembly 14 or 12 and is twist-locked into position by means of the locking tabs 56.

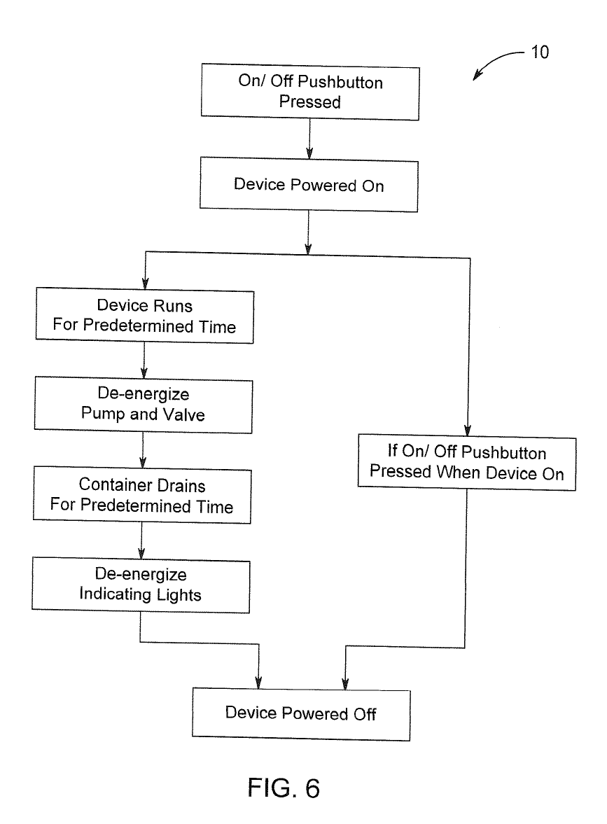

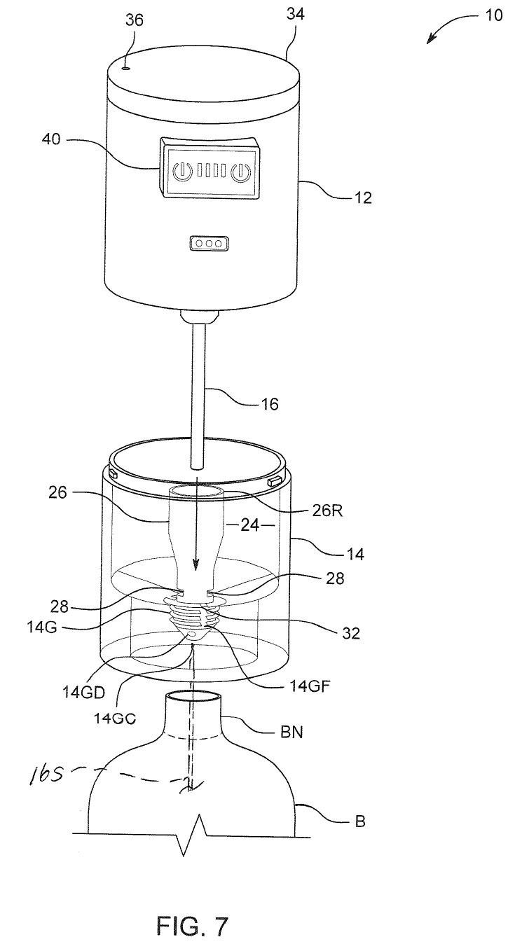

FIG. 6 shows the control sequence for the aerator 10. FIG. 7 is an exploded diagram showing how the upper assembly 12 is twist-locked to the lower assembly 14 with the intake tube 16 sliding into the drainpipe 26 and then how the now-assembled aerator is then mounted to the neck of the bottle B.

When the on/off push button is pressed on control panel 40, Aerator 10 is powered on, and the electrical components are energized. Valve 22 closes and pump 18 draws wine through suction tube 16S and intake tube 16. Pump 18 discharges wine into reservoir 24 where it is mixed with air providing preliminary aeration. As wine is pumped from the bottle B, reservoir 24 begins to fill with wine and air is drawn into the bottle B through vents 32 in the base B.

In the preferred embodiment, bleed holes 28 at the bottom of reservoir 24 drain about 50 percent of the wine being discharged by the pump 18 during operation. Reservoir 24 therefore receives a greater percentage of wine by filling than by draining. As the wine level in the reservoir 24 rises to the top of reservoir 24, the wine flows over the upper rim 26R of drainpipe 26. Wine thus drains back into the headspace H of the bottle B.

As the reservoir 24 is filled with wine, the volume of wine removed from the bottle B is replaced with an equivalent volume of air in the bottle B via the radial vent holes 32 formed within the gasket 14G. Wine continuously drains out of reservoir 24 via the overflow drainpipe 26 and bleed holes 28, to drain through the air inside the headspace H of the bottle B for aeration.

After aeration, aerator 10 is removed from the bottle B.

Thus, the advantages of an aerator become evident:
(a) Aerating wine in a bottle alleviates having to transfer the wine to another reservoir.
(b) Aerating wine in a bottle without generating bubbles prevents a buildup of foam that can overflow out of the bottle.
(c) Continuously flowing wine through air enhances the flavor of the wine and reduces the aeration time, allowing a consumer to enjoy the flavor enhanced wine much sooner.
(d) Aerating wine is achieved without imparting a bubbly appearance to the wine.

It should be appreciated that the subject invention provides a more reliable aerator device (1) to bring out the full flavors and aromas of the wine, (2) that aerates wine in its original bottle eliminates the need to transfer the wine to another vessel; (3) that continuously mixes wine with air to reduce the time to aerate the wine, and (4) to increase the enjoyment of aerated wine sooner, without generating bubbles prevents the buildup of foam and bubbly looking wine.

While my above description contains many specificities, these should not be construed as limitations on the scope, but rather as an exemplification of one embodiment thereof. For example, the use of one or more disposable alkaline batteries instead of a rechargeable battery will eliminate the battery charging port and battery charging circuit. Another example includes a wireless communication system, such as Bluetooth or WIFI, incorporated into the aerator so that the device may be monitored or controlled by another device such as a cellphone or a computer. Another example includes exchanging the electrically operated solenoid air valve with a mechanical air valve. In yet another example, the pump intake tube can be made part of the bottom panel as one integral part. Accordingly, the scope of the disclosure should be determined not by the embodiment illustrated, but by the appended claims and their legal equivalents.

The present invention includes that contained in the appended claims as well as that of the foregoing description. Although this description has been described in its preferred form with a certain degree of particularity, it should be understood that the present disclosure of the preferred form has been made only by way of example and that numerous changes in the details of construction, combination, or arrangement of parts thereof may be resorted to without departing from the spirit and scope of the invention.

Now that the invention has been described,

What is claimed is:

1. A method for aerating wine from a bottle comprising the steps of:
pumping wine from the bottle into a reservoir mounted relative to a neck of the bottle to create a headspace within the bottle therein exposed to atmospheric air; and
directing wine overflowing from the reservoir back into the headspace of the bottle, thereby aerating the wine in the bottle.

2. The method as set forth in claim 1, further including the steps of draining the reservoir of wine after pumping back into the remaining headspace of the bottle.

3. The method as set forth in claim 2, wherein the step of directing wine overflowing from the reservoir back into the headspace of the bottle comprises an overflow functioning as a weir to determine the height of the wine in the reservoir, with overflowing wine flowing into the overflow back into the bottle thereby aerating the overflowed wine within the bottle.

4. The method as set forth in claim 3, wherein the overflow comprises a drainpipe.

5. The method as set forth in claim 3, wherein the step of draining the reservoir of wine comprises the step of draining the reservoir through bleed holes, back into the bottle, thereby aerating reservoir-drained wine within the bottle.

6. The method as set forth in claim 3, wherein said lower assembly comprises a downwardly extending boss dimensioned to fit into the neck of the bottle.

7. The method as set forth in claim 6, wherein said lower assembly further comprises a gasket fitted to said boss.

8. The method as set forth in claim 7, further comprising the step of flowing the wine through an intake tube fitted through the boss and through a center hole formed in the gasket.

9. The method as set forth in claim 3, further including the step of positioning said reservoir elevationally below an output of the pump.

10. The method as set forth in claim 4, wherein said drainpipe is positioned vertically within the reservoir with its upper rim functioning as a weir to determine the level of wine in the reservoir and with its discharge end fluidly connected to the headspace above the level of the wine in the bottle.

11. The method as set forth in claim 3, wherein said overflow comprises a drainpipe configuration to continuously drain overflowing wine from the reservoir.

12. The method as set forth in claim 3, wherein the bleed holes are positioned in a bottom portion of the reservoir.

13. The method as set forth in claim 3, further including the step of flowing wine into reservoir at a rate appreciably greater than the rate the wine bleeds out from the reservoir from bleed hole(s).

14. The method as set forth in claim 13, wherein said bleed holes comprises press-fitting the lower rim of the drainpipe onto an upstanding crenellated annular drain hole formed in the bottom of the reservoir.

15. The method as set forth in claim 13, wherein said bottom of reservoir is preferably sloped downwardly toward the overflow to enhance drainage of the reservoir.

16. The method as set forth in claim 14, where said drainpipe and boss are concentric with one another such that the intake tube is positioned concentrically within the drainpipe.

17. The method as set forth in claim 16, wherein the bleed holes are in fluid communication with an annular space between the outside of the intake tube and the inside of the center hole of the boss such that wine being continuously bled from the reservoir via the bleed holes drains out of the gasket via drain holes and flow by gravity along inside the headspace of the bottle with some wine draining along the inside surface of the bottle for full aeration.

18. The method as set forth in claim 7, wherein the wine overflowing the weir of the drainpipe flows into the headspace in the bottle.

19. The method as set forth in claim 7, wherein said gasket comprises a T-hat configuration with a plurality of radial slots functioning as air vents formed in the brim to allow atmospheric air to freely flow into the headspace of the bottle at all times.

20. The method as set forth in claim 19, wherein said gasket comprises a plurality of pliable horizontal fins that may more securely affix the boss in the bottleneck.

21. The method as set forth in claim 1, wherein said upper assembly and said lower assembly are complementarily twist-locked together during initial set-up.

22. The aerator set forth in claim 1, further including the step of venting said intake tube during initial set-up.

23. A wine aerator for aerating wine in a bottle, comprising in combination:
a reservoir mounted relative to the neck of the bottle;
a pump for pumping wine from the bottle into the reservoir to create a headspace within the bottle exposed to atmospheric air; and
a drainpipe for directing wine overflowing from the reservoir back into the headspace of the bottle, thereby aerating the wine in the bottle.

24. The aerator as set forth in claim 23, further including at least one bleed hole for draining the reservoir of wine into the headspace of the bottle.

25. The aerator as set forth in claim 24, wherein an upper edge of said drainpipe functions as a weir to determine the height of the wine in the reservoir, with overflowing wine flowing into the drainpipe into the bottle thereby aerating the overflowed wine within the bottle.

26. The aerator as set forth in claim 23, further comprising a downwardly extending boss dimensioned to fit into the neck of the bottle.

27. The aerator as set forth in claim 26, further comprising a gasket fitted to said boss.

28. The aerator as set forth in claim 27, wherein said intake tube fits through the boss and through a center hole formed in the gasket.

29. The aerator as set forth in claim 23, wherein said reservoir is positioned elevationally below an output of the pump when mounted into the bottle.

30. The aerator as set forth in claim 29, wherein said drainpipe is positioned vertically within the reservoir with its discharge end fluidly connected to the headspace above the level of the wine in the bottle.

31. The aerator as set forth in claim 30, wherein overflowing wine from the reservoir runs down the outer surface of a suction tube fluidly connected to the intake tube and/or along the interior surface of the bottle.

32. The aerator as set forth in claim 31, further including one or more bleed holes positioned in a bottom of the reservoir.

33. The aerator as set forth in claim 32, wherein said pump discharges wine at a rate of flow greater than the rate the wine bleeds out from the reservoir from said bleed hole(s).

34. The aerator as set forth in claim 33, wherein a lower rim of the drainpipe is press fitted onto an upstanding crenellated annular drain hole formed in the bottom of the reservoir to form the bleed holes.

35. The aerator as set forth in claim 33, wherein said bottom of reservoir is sloped downwardly toward the bleed holes to enhance drainage of the reservoir.

36. The aerator as set forth in claim 35, wherein said drainpipe and boss are concentric with one another such that the intake tube is positioned concentrically within the drainpipe.

37. The aerator as set forth in claim 36, wherein the bleed holes are in fluid communication with an annular space between the outside of the intake tube and the inside of the center hole of the boss such that wine being continuously bled from the reservoir via the bleed holes drains out of the gasket via drain holes and flow by gravity along inside the headspace of the bottle with some wine draining along the inside surface of the bottle for full aeration.

38. The aerator as set forth in claim 37, wherein the wine overflowing the weir of the drainpipe flows into the headspace in the bottle.

39. The aerator as set forth in claim 38, wherein said gasket comprises a T-hat configuration with a plurality of radial slots functioning as air vents formed in the brim to allow atmospheric air to freely flow into the headspace of the bottle at all times.

40. The aerator as set forth in claim 39, wherein said gasket comprises a plurality of pliable horizontal fins that may more securely affix the boss in the bottleneck.

41. The aerator as set forth in claim 23, wherein said upper assembly and said lower assembly are complementarily twist-locked together during initial set-up.

42. The aerator set forth in claim 24, further including the step of venting said intake tube during initial set-up.
